(19) United States
(12) Patent Application Publication
(10) Pub. No.: US 2022/0320668 A1
(43) Pub. Date: Oct. 6, 2022

(54) VEHICLE BATTERY CASE APPARATUS

(71) Applicants: Hyundai Motor Company, Seoul (KR); Kia Corporation, Seoul (KR)

(72) Inventors: Hyeon Jun KIM, Gunpo (KR); Hui Tae YANG, Cheonan (KR); Jong Wook LEE, Hwaseong (KR); Beom Joo KWON, Suwon (KR); Tae Hyuck KIM, Asan (KR)

(21) Appl. No.: 17/534,690

(22) Filed: Nov. 24, 2021

(30) Foreign Application Priority Data
Apr. 2, 2021 (KR) 10-2021-0043421

(51) Int. Cl. H01M 50/249; B60K 1/04; H01M 50/244; H01M 50/502

(52) U.S. Cl. CPC H01M 50/249; B60K 1/04; H01M 50/244; H01M 50/502; H01M 2220/20

(57) ABSTRACT

A vehicle battery case apparatus includes a lower case provided with a high-voltage battery and an electric unit; an upper case coupled to an upper portion of the lower case; a module unit into which the electric unit is built and which is mounted in a front portion of the lower case; and a connector unit electrically connected to the electric unit by being installed in the module unit through the upper case in a state in which the upper case is mounted on the lower case to cover the module unit. Further, the electric unit may be a power relay assembly (PRA) arranged in a front portion of a vehicle body so as to secure an additional rear interior space, where a connector connected to the PRA has a height protruding upwardly with respect to the lower case so as to ensure stability against collisions.

### CROSS REFERENCE TO RELATED APPLICATION

The present application claims under 35 U.S.C. § 119(a) the benefit of Korean Patent Application No. 10-2021-0043421, filed Apr. 2, 2021, the entire contents of which are incorporated by reference herein.

### BACKGROUND

### 1. Technical Field

The present disclosure relates to a vehicle battery case apparatus, more particularly, to the vehicle battery case apparatus configured to provide an additional rear interior space in a vehicle and for preventing damage to electric components in the event of a vehicle collision.

### 2. Description of the Related Art

In recent years, interest in environmentally-friendly vehicles has increased due to more stringent regulations, high oil prices, and the like, and various electric vehicles configured to be driven using electric energy have been developed.

Examples of electric vehicles include a battery-powered electric vehicle (EV), a fuel cell EV using a fuel cell as an electrical power source, and a hybrid EV using a motor and an engine.

In particular, in the case of an electric vehicle, a battery module is provided to store electrical energy, and the battery module includes a plurality of battery cell units accommodated in a battery housing. In such a battery module, it is necessary to prevent damage to the battery cell units from external shocks.

In the related art, there are devices for preventing damage only to a battery cell unit, and there is no device or method of protecting a high-voltage cable or a high-voltage connector connected to the battery cell unit.

In addition, in developing an electric vehicle, the utilization of interior space is important. When a battery case is provided under a vehicle body, there is a problem in that interior space is consumed due to the presence of various electric components.

The matters described above as the background art are provided only for promoting the understanding of the background of the present disclosure, and the foregoing description of the background art should not be construed as admitting that the matters described above correspond to the prior art already known to those skilled in the art.

### SUMMARY

The present disclosure provides a vehicle battery case apparatus that enables rear interior space to be secured and avoids damage to electric components when a vehicle collision occurs.

In view of the foregoing, a vehicle battery case apparatus according to the present disclosure includes: a lower case provided with a high-voltage battery and an electric unit (i.e., at least one electric unit); an upper case coupled to an upper portion of the lower case; a module unit into which the electric unit is built and which is mounted in a front portion of the lower case; and a connector unit electrically connected to the electric unit by being installed in the module unit through the upper case in the state in which the upper case is mounted on the lower case to cover the module unit.

The electric unit built into the module unit may be a power relay assembly (PRA).

The module unit may be disposed between the seats at the front side of the lower case.

The module unit may be mounted above the lower case via a mounting unit so as to be provided above a high-voltage battery.

The mounting unit may include a panel portion configured to allow the module unit to be seated thereon and leg portions extending from opposite side ends of the panel unit toward the lower case.

The module unit and the connector unit may be connected to each other via a bus bar unit exposed to the outside of the upper case through the upper case in a front portion of the module unit.

The bus bar unit may include a mounting portion configured to allow the connector unit to be inserted into the bus bar unit and to be electrically connected to the module unit, and a rib portion extending on a circumferential surface of the mounting portion so as to come into contact with an inner surface of the upper case.

The bus bar unit may further include a sealing unit provided to match the rib portion and to be mounted on the rib portion on the outer surface of the upper case to come into contact (i.e., close contact) with the outer surface of the upper case.

The module unit may be disposed to be spaced apart rearwards from the front portion of the lower case such that the connector unit installed in the module unit does not protrude further forward than the lower case.

The module unit may include a lower cover, which is fixedly mounted on the lower case so as to define a mounting space in the lower case in which the electric unit is seated, and which is connected to the connector unit at a front side of the connected unit, and an upper cover, which is mounted on the upper portion of the lower cover so as to close the mounting space, and which is provided with a pad unit on a top surface of the upper cover so as to absorb shocks applied to the upper case.

The upper case may include in the front portion of the upper case an accommodation portion, which is curved upwards so as to surround the module unit.

The vehicle battery case apparatus may further include a vehicle body above the upper case, and the vehicle body may include a portion formed in a protruding shape to match the accommodation portion of the upper case.

The portion formed in the vehicle body to match the accommodation portion of the upper case may be shaped through a hot stamping method.

In the vehicle battery case apparatus having the structure described above, because the PRA is arranged in the front portion of the vehicle body, an additional rear interior space is secured. Further, since the connector connected to the PRA is arranged with a height protruding upwardly with respect to the lower case, an ability to withstand a front collision and a lower collision is ensured.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a view illustrating a vehicle battery case apparatus according to the present disclosure;

FIG. 2 is a plan view of the vehicle battery case apparatus illustrated in FIG. 1;

FIG. 3 is a side cross-sectional view of the vehicle battery case apparatus illustrated in FIG. 1;

FIG. 4 is a view for describing a module unit;

FIG. 5 is a view for describing the mounting state of a module unit;

FIG. 6 is a view for describing a module unit and a connector unit; and

FIG. 7 is a view illustrating the mounting of the module unit between a lower case and an upper case.

### DETAILED DESCRIPTION OF THE EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, a vehicle battery case apparatus according to an embodiment of the present disclosure will be described with reference to the accompanying drawings.

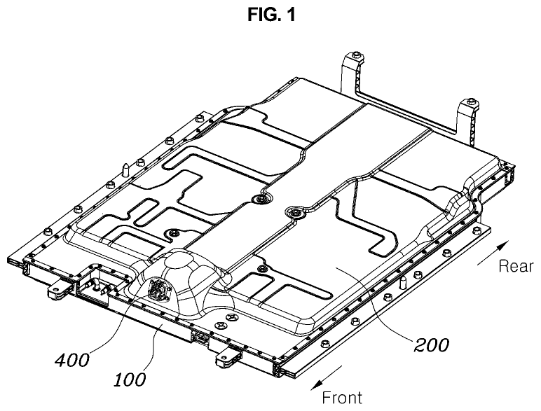

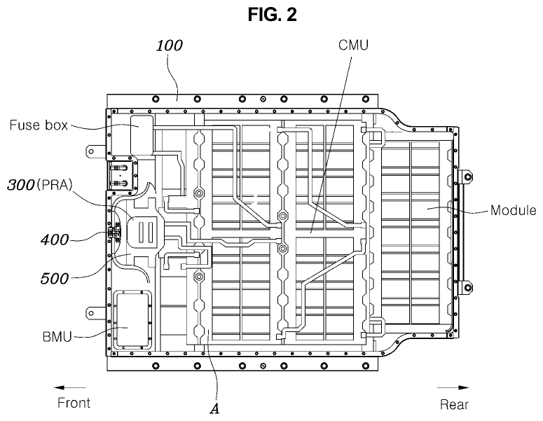

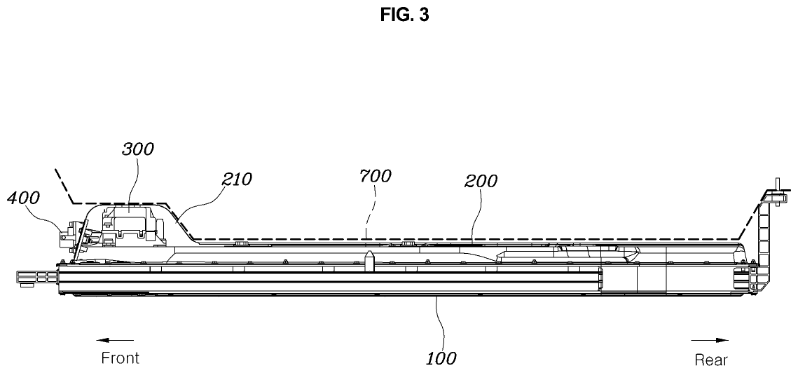

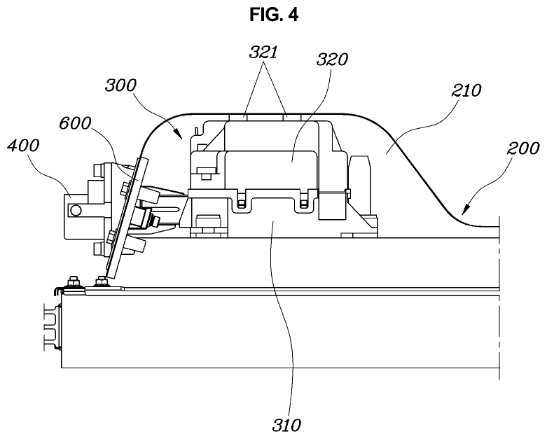

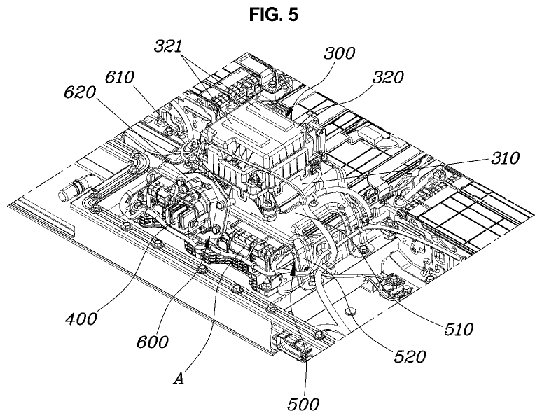

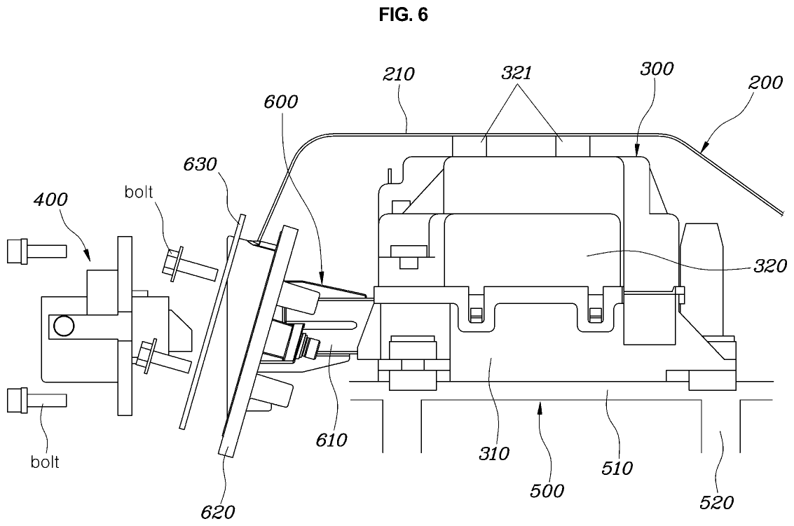

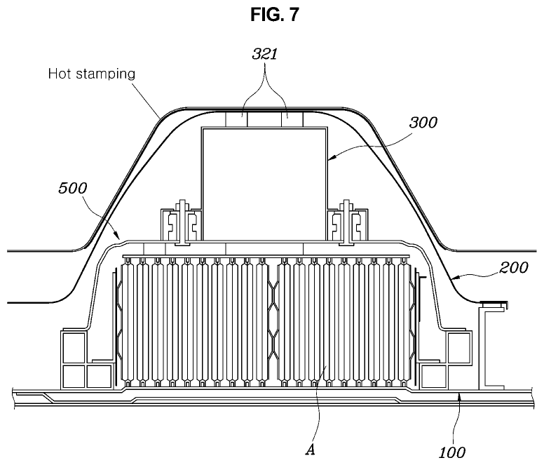

FIG. 1 is a view illustrating a vehicle battery case apparatus according to the present disclosure, FIG. 2 is a plan view of the vehicle battery case apparatus illustrated in FIG. 1, and FIG. 3 is a side cross-sectional view of the vehicle battery case apparatus illustrated in FIG. 1. FIG. 4 is a view for describing a module unit, FIG. 5 is a view for describing the mounting state of a module unit, FIG. 6 is a view for describing the module unit and a connector unit, and FIG. 7 is a view illustrating the mounting of the module unit between a lower case and an upper case.

As illustrated in FIGS. 1 and 2, the present disclosure relates to a vehicle battery case apparatus including a lower case 100 in which a high-voltage battery A and an electric unit B (i.e., at least one electric unit) are provided, and an upper case 200 coupled to an upper portion of the lower case 100.

The battery case including the lower case 100 and the upper case 200 as described above is disposed under a vehicle body 700 and mounted on the vehicle body 700. Here, in the lower case 100, the high-voltage battery A and one or more electric units are built in, and are electrically connected to each other. The upper case 200 is coupled to the upper portion of the lower case 100, and the upper case 200 includes an accommodation portion 210 bent upwards in the front portion of the upper case 200 so as to surround a module unit 300 installed in the lower case 100 with a height protruding upwardly.

A vehicle body 700 is provided above the upper case 200, and a portion formed in a protruding shape is provided on the vehicle body 700 to match the accommodation portion 210 of the upper case 200. In addition, the portion formed in the vehicle body 700 to match the accommodation portion 210 of the upper case 200 may be shaped through a hot stamping method.

In this way, in the case of the vehicle body 700, the portion matching the accommodation portion 210 protrudes so that the accommodation portion 210 of the upper case 200 is capable of being accommodated in the portion matching the accommodation portion 210 together with the module unit 300. Since the matching portion is formed through a hot stamping method, the rigidity of the corresponding area is reinforced.

Meanwhile, electric units may include a fuse box, a cell-monitoring unit (CMU), a battery management unit (BMU), a power relay assembly (PRM), and the like.

In particular, in the present disclosure, each electric unit may be disposed in the front portion of the battery case. In addition, in the case of the PRM, to which a high-voltage connector is connected, it is necessary to secure an installation height Since the PRM is installed in the front portion of the lower case 100, an additional rear interior space is secured, thereby increasing the degree of freedom of a package concept required by an electric vehicle.

For this purpose, as illustrated in FIGS. 1 to 3, in the vehicle battery case apparatus according to the present disclosure, the module unit 300 having the built-in electric units is mounted in the front portion of the lower case 100, and in the state in which the upper case 200 is mounted on the lower case 100 to cover the module unit 300, a connector unit 400 passes through the upper case 200 and is electrically connected to the electric units via the module unit 300.

Here, the electric units built into the module unit 300 include a power relay assembly (PRA), and since the module unit 300 is mounted in the front portion of the lower case 100, the PRA is also disposed in the front portion. As a result, because electric vehicle components such as a drive motor connected to the PRA are disposed in the front portion of the vehicle, the distance between the electric vehicle components and the PRA is reduced, thereby reducing the lengths of cables connecting the electric vehicle components to the PRA. Accordingly, it is possible to arrange the cables to avoid damage to the cables in the event of a vehicle collision, and thus to prevent problems occurring due to damage to the cables.

Meanwhile, the module unit 300 is provided with a connector unit 400 for connecting the cables. As illustrated in FIG. 4, the module unit 300 is mounted on the lower case 100, and the upper case 200 is coupled to the lower case 100 to cover the module unit 300 as well as the lower case 100, whereby the module unit 300 is protected in the space between the upper case 200 and the lower case 100. In this way, in the state in which the upper case 200 is mounted on the lower case 100 to cover the module unit 300, the connector unit 400 is installed in the module unit 300 through the upper case 200. Thus, the electric units of the module unit 300 are capable of being electrically connected to other electric components including a driving motor.

In the present disclosure, since the module unit 300 is mounted on the lower case 100 and is covered by the upper case 200 as described above, the module unit 300 is protected from the outside. In particular, through the installation position of the module unit 300 and the relationship between the module unit and the upper case 200, an additional rear interior space is secured and collision safety is assured.

When describing the present disclosure in detail, the module unit 300 may be disposed at the center of the front portion of the lower case 100. That is, since the module unit 300 is disposed at the center of the front portion of the lower case 100, it is possible to dispose the module unit 300 between seats so as to minimize the influence on interior space package. For example, since the module unit 300 is disposed in the front portion between the driver's seat and the front passenger seat, the module unit 300 does not interfere with either seat. Further, since the module unit 300 is disposed to be spaced apart from the driver's seat, pedal installation space and space for the driver's feet are secured.

Meanwhile, as illustrated in FIG. 5, the module unit 300 is mounted in the upper portion of the lower case 100 via a mounting unit 500, and is provided above a high-voltage battery A. The module unit 300 is installed in the mounting part 500 so as to have a height protruding upwardly from the lower case 100 so that the module unit 300 is provided above the high-voltage battery A. Since the module unit 300 is provided above the high-voltage battery A via the mounting unit 500, it is possible to reduce the distances between the electric units associated with the high-voltage battery A within the module unit 300 and to optimize the package of each electric unit. That is, components such as a current sensor are provided in the module unit 300 in addition to the PRA so that the package of electric units, such as a relay and pre-charger resistor, is optimized. In addition, the amount of space for providing electric units is reduced by optimizing the package through the module unit 300. Accordingly, space for providing a cross member in the vehicle body 700 is secured, thereby increasing the degree of freedom of installation of the cross member.

The mounting unit 500 may include a panel portion 510 formed so as to allow the module unit 300 to be seated thereon and leg parts 520 extending from opposite side ends of the panel portion 510 toward the lower case 100. As can be seen from FIG. 5, the mounting unit 500 includes the panel portion 510 and leg portions 520, wherein the panel portion 510 is formed in the shape of a plane so as to allow the module portion 300 to be seated thereon, and the leg portions 520 extend from the opposite side ends of the panel portion 510 toward the lower case 100, avoiding the high-voltage battery A. Here, a plurality of leg portions 520 are formed at the opposite side ends of the panel portion 510 so as to secure rigidity of coupling to the lower case 100 and to enable four-point support as illustrated in the drawing. This makes it possible to obtain a structure in which the high-voltage battery A is arranged in the first stage in the vertical direction in the lower case 100 and the module unit 300 is arranged in the second stage above the high-voltage battery A with the help of the mounting unit 500, thereby reducing the overall size of the package and simplifying the connection between the electric units provided in the module unit 300 and the high-voltage battery A.

Meanwhile, as illustrated in FIG. 6, the module unit 300 and the connector unit 400 may be connected to each other via a bus bar unit 600 exposed to the outside the upper case 200 in front of the module unit 300 through the upper case 200. That is, the module unit 300 is located inside the upper case 200 by being covered by the upper case 200, and the connector unit 400 is located outside the upper case 200 for connection with other electric components. It is necessary for the module unit 300 and the connector unit 400 to be electrically connected to each other, and thus the bus bar unit 600 is exposed to the outside of the upper case 200 in front of the module unit 300 through the upper case 200. For this reason, when the connector unit 400 is inserted into and connected to the bus bar unit 600, the connector unit 400 may be electrically connected to the electric units of the module unit 300 via the bus bar unit 600.

Since the bus bar unit 600 is configured such that it is coupled to the module unit 300 and the connector unit 400 is fastened thereto as described above, the bus bar unit 600 serves as a medium that enables the connector unit 400 and the electric units of the module unit 300 to be electrically connected to each other when the connector unit 400 is fastened to the bus bar unit 600.

The bus bar unit 600 may include a mounting portion 610 formed to be inserted into the connector unit 400 and electrically connected to the module unit 300, and a rib portion 620 extending on a circumferential surface of the mounting portion 610 to come into contact with the inner surface of the upper case 200. As can be seen from FIG. 6, the bus bar unit 600 includes the mounting portion 610 and the rib portion 620. The mounting portion 610 is coupled to the module unit 300 at one side of the mounting portion 610 so as to be electrically connected to the module unit 300, and extends forward from the module unit 300 at the other side of the mounting portion 610 through the upper case 200. At the end of the other side of the mounting portion 610, an insertion end 311 into which the connector unit 400 is inserted is formed. Thus, when the connector part 400 is inserted into the insertion end 311, the connector unit 400 is capable of being electrically connected to the module unit 300 via the bus bar unit 600.

In particular, the rib portion 620 extends along the circumferential surface of the mounting portion 610. The rib portion 620 is configured to come into contact with the inner surface of the upper case 200. Accordingly, a force for supporting the bus bar unit 600 with respect to the upper case 200 is generated to stabilize the installation of the bus bar unit 600, and since the rib portion 620 is in contact with the upper case 200, the gap between the rib portion 620 and the upper case 200 is removed and hermetically sealed. In addition, since space for bolting or riveting the bus bar unit 600 to the upper case 200 is secured through the rib portion 620, it is easy to mount the bus bar unit 600 in the upper case 200.

In addition, the bus bar unit 600 may further include a sealing unit formed to match the rib portion 620 and mounted on the rib portion 620 on the outer surface of the upper case 200 so as to be in contact with (i.e., close contact with) the outer surface of the upper case 200. Accordingly, in the state in which the rib part 620 is brought into contact with the inner surface of the upper case 200 and the sealing part 630 is located to match the rib portion 620 on the outer surface of the upper case 200 such that the bus bar unit 600 comes into contact with the upper case 200, the rib portion 620 and the sealing unit 630 may be coupled to each other through bolting or riveting. Accordingly, it is possible to firmly couple the bus bar unit 600 to the upper case 200 via the rib portion 620 and the sealing unit 630. In addition, the sealing unit 630 is brought into contact with (i.e., close contact with) the outer surface of the upper case 200 to ensure a hermetic seal, whereby moisture generated from the outside of the upper case 200 is blocked from flowing into the module unit 300. Here, a sealing material may be additionally provided between the sealing unit 630 and the upper case 200.

Meanwhile, the module unit 300 is disposed to be spaced apart from the front portion of the lower case 100 to the rear side such that the connector unit 400 installed in the module unit 300 does not protrude to the front side of the lower case 100. Accordingly, even if a front collision occurs, a direct impact to the connector unit 400 is avoided because the connector unit 400 does not protrude from the lower case 100.

In addition, the module unit 300 may include a lower cover 310 fixedly mounted on the lower case 100 so as to define a mounting space in the lower case 100, in which the electric units are seated, and connected to the connector unit 400 at the front side of the connection unit 400, and an upper cover 320 mounted on the upper portion of the lower cover 310 so as to close the mounting space and provided with pad units 321 on the top surface of the upper cover 320 so as to absorb shocks applied to the upper case 200.

Since the module unit 300 is configured to be divided into the lower cover 310 and the upper cover 320 as described above, it is possible to improve convenience of assembly of the module unit 300 by installing the electric units in the mounting space in the lower cover 310 and then covering the upper cover 320. In particular, because the pad units 321 are provided on the top surface of the upper cover 320 so as to come into contact with the upper case 200, the transmission of shocks caused by direct contact between the module portion 300 and the upper case 200 is reduced.

In the vehicle battery case apparatus having the structure described above, because the PRA (among one or more electric units) is arranged in a front portion of the vehicle body, an additional rear interior space is secured. Further, since the connector connected to the PRA is arranged with a height protruding upwardly with respect to the lower case, an ability to withstand a front collision and a lower collision is ensured.

While the present disclosure has been illustrated and explained with respect to specific embodiments thereof, it will be obvious to a person ordinarily skilled in the art that the present disclosure can be variously modified and changed without departing from the scope of the technical idea of the present disclosure, which is defined by the accompanying claims.

What is claimed is:

1. A vehicle battery case apparatus, comprising:
a lower case provided with a high-voltage battery and an electric unit;
an upper case coupled to an upper portion of the lower case;
a module unit into which the electric unit is built and which is mounted in a front portion of the lower case; and
a connector unit electrically connected to the electric unit by being installed in the module unit through the upper case in a state in which the upper case is mounted on the lower case to cover the module unit.

2. The vehicle battery case apparatus of claim 1, wherein the electric unit built into the module unit is a power relay assembly (PRA).

3. The vehicle battery case apparatus of claim 1, wherein the module unit is disposed at a center of the front portion of the lower case.

4. The vehicle battery case apparatus of claim 1, wherein the module unit is mounted above the lower case via a mounting unit so as to be provided above a high-voltage battery.

5. The vehicle battery case apparatus of claim 4, wherein the mounting unit includes a panel portion configured to allow the module unit to be seated thereon and leg portions extending from opposite side ends of the panel unit toward the lower case.

6. The vehicle battery case apparatus of claim 1, wherein the module unit and the connector unit are connected to each other via a bus bar unit exposed to an outside of the upper case through the upper case in a front portion of the module unit.

7. The vehicle battery case apparatus of claim 6, wherein the bus bar unit includes a mounting portion configured to allow the connector unit to be inserted into the bus bar unit and to be electrically connected to the module unit, and a rib portion extending on a circumferential surface of the mounting portion so as to come into contact with an inner surface of the upper case.

8. The vehicle battery case apparatus of claim 7, wherein the bus bar unit further includes a sealing unit provided to match the rib portion and to be mounted on the rib portion in an outer surface of the upper case to come into contact with the outer surface of the upper case.

9. The vehicle battery case apparatus of claim 1, wherein the module unit is disposed to be spaced apart rearwards from the front portion of the lower case such that the connector unit installed in the module unit does not protrude further forward than the lower case.

10. The vehicle battery case apparatus of claim 1, wherein the module unit includes a lower cover fixedly mounted on the lower case so as to define a mounting space in the lower case, in which the electric unit is seated, and connected to the connector unit at a front side of the connector unit, and an upper cover mounted on an upper portion of the lower cover so as to close the mounting space and provided with a pad unit on a top surface of the upper cover so as to absorb a shock applied to the upper case.

11. The vehicle battery case apparatus of claim 1, wherein the upper case includes in a front portion of the upper case an accommodation portion, which is curved upwards so as to surround the module unit.

12. The vehicle battery case apparatus of claim 11, wherein a vehicle body is provided above the upper case and includes a portion formed in a protruding shape to match the accommodation portion of the upper case.

13. The vehicle battery case apparatus of claim 12, wherein the portion formed in the vehicle body to match the accommodation portion of the upper case is shaped through a hot stamping method.
